(19) United States
(12) Patent Application Publication
(10) Pub. No.: US 2007/0241582 A1
(43) Pub. Date: Oct. 18, 2007

(54) Integrated Umbrella Holder For Vehicle

(75) Inventor: Joseph McKeever, Troy, MI (US)

Correspondence Address: GROSSMAN, TUCKER, PERREAULT & PFLEGER, PLLC, 55 SOUTH COMMERICAL STREET, MANCHESTER, NH, 03101, US

(73) Assignee: Collins & Aikman Products Co., Southfield, MI (US)

(21) Appl. No.: 11/697,659

(22) Filed: Apr. 6, 2007

Related U.S. Application Data
(60) Provisional application No. 60/744,704, filed on Apr. 12, 2006.

(51) Int. Cl. B60R 7/06

(52) U.S. Cl. 296/37.12

(57) ABSTRACT

An umbrella holder for a vehicle is provided, comprising a tube for receiving a collapsed umbrella, wherein the tube may be integrated into an end portion of an instrument panel. The tube may be angled downward and vented for drainage to the outside at a lower end. The upper end of the tube may cooperate with a depression in the adjacent door panel to allow the handle of the umbrella to protrude from the end of the instrument panel for relatively easy access when the vehicle door is opened.

### CROSS REFERENCE TO RELATED APPLICATIONS

The present application claims the benefit of the filing date of U.S. Provisional Application Ser. No. 60/744,704, filed Apr. 12, 2006, the teachings of which are incorporated herein by reference.

### FIELD OF INVENTION

The present invention relates generally to an umbrella holder, and more particularly, to an umbrella holder integrated into a trim panel of a vehicle.

### BACKGROUND OF THE INVENTION

Most vehicle owners carry an umbrella in their vehicle for use in the event of inclement weather. Storage and convenient access pose serious problems which may, at least in part, provide an explanation as to why umbrella holders have not achieved commercial success in vehicles.

It is preferred that an umbrella be instantly available upon opening a door, so that an occupant of a vehicle will not get wet. Currently, umbrellas are often stored under the front seat, in a back seat or even in the trunk. Such an inconvenience necessarily means that the user will get wet while obtaining the umbrella.

The storage of a wet umbrella presents a problem as well, as it may render other surfaces (seat, floor, etc.) wet which may in turn produce puddles, mildew, rust, etc. This is, of course, objectionable. In addition, the random storage of umbrellas essentially ensures that they will become damaged, as items are placed on top of them or that they may become stepped upon.

Further, special holders which are not integrated into the interior of the vehicle are generally unsightly and must be assembled/installed by the vehicle owner. This may take away from the pleasure of owning a new vehicle.

In today's vehicles, cargo/storage space is at a premium. What is needed is a holder for a wet umbrella that may be integrated into the interior theme of the vehicle, that does not detract from a pleasing appearance, that is instantly accessible upon departing the vehicle and that does not take up significant storage space. What is also needed is a method to drain the water from the wet umbrella and assist in the drying process.

### SUMMARY OF THE INVENTION

A holder for an umbrella may be integrated into a trim panel adjacent a door in a vehicle. The holder may generally be tubular in shape and may be angled downward. The lower end of the holder may include an opening, as well as draining means to direct any water to the outside of the vehicle.

The holder may be integrated into an end of the instrument panel such that the handle end of the umbrella may protrude slightly into a depression in the adjacent door panel when the door is closed. This then may allow an occupant to grasp the handle before departing the vehicle and open the umbrella before getting wet.

The holder may be a molded tube with an opening that the umbrella protrudes through, the opening sculpted and finished to coordinate with the aesthetics and interior theme of the vehicle.

### BRIEF DESCRIPTION OF THE DRAWINGS

These and other objects, features and advantages of the present invention will become apparent to those skilled in the art upon reference to the following written description and accompanying drawings in which:

FIG. 1 is a perspective view looking in the driver's side door of a vehicle at the end of the instrument panel and adjacent door panel, illustrating an integrated umbrella holder and umbrella.

FIG. 2 is a cross-sectional view along lines 2-2 of FIG. 1 illustrating the umbrella holder according to the present invention with the driver's side door closed.

### DETAILED DESCRIPTION OF THE INVENTION

The present invention is described more fully hereinafter with reference to the accompanying drawings, in which preferred embodiments of the invention are shown. This invention, may, however, be embodied in many different forms and should not be construed as limited to the embodiments set forth herein. Rather, these embodiments are provided so that this disclosure will be thorough and complete and will convey the scope of the invention to those skilled in the art.

In the drawings, the thickness of lines, layers and regions may be exaggerated for clarity. It will be understood that when an element such as a layer, region, substrate, or panel is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like are used herein for the purpose of explanation only.

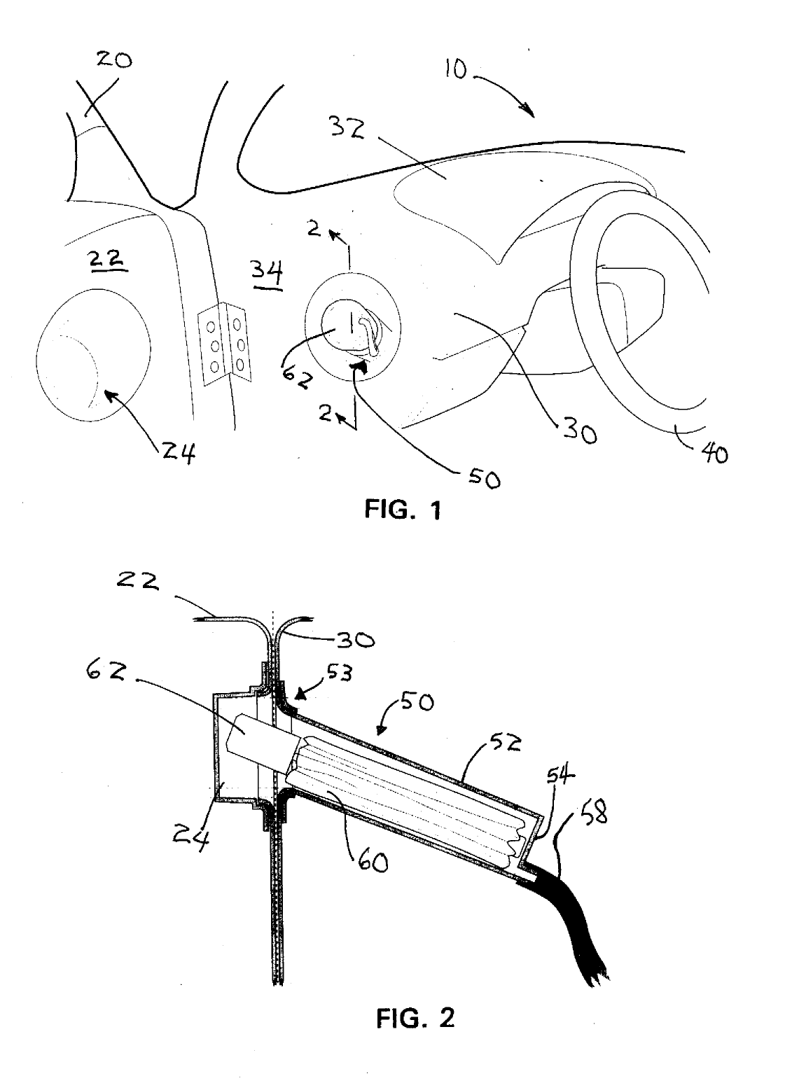

FIG. 1 is a perspective view of the interior 10 of a vehicle as seen from the driver's side with the driver's side door 20 open. The interior includes an instrument panel 30, including a driver's side cluster 32 and steering wheel 40. An umbrella holder 50 is integrated into the end 34 of the instrument panel 30. The holder 50 includes a tube 52 which may contain an umbrella 60. The end 62 of the umbrella 60 may protrude outward beyond the surface of the panel 30. The door 20 further includes a door panel 22 which may cover the mechanical apparatus associated with window and door latching/locking operations. The door panel 22 may further include a depression 24 to accept the protruding end 62 of the umbrella 60 when the door 20 of the vehicle is closed. This may allow relatively instant access by the occupant to the umbrella, in this case the driver, without having to depart the vehicle by fully or even partially opening the door.

FIG. 2 illustrates a cross-sectional view of the umbrella holder 50 integrated into the instrument panel 30 and coordinating with the adjacent door panel 22 when the door is closed, taken along line 2-2 of FIG. 1.

In this exemplary embodiment, the holder 50 preferably comprises a plastic tube 52 slightly larger in diameter than a collapsed umbrella 60. In addition, the holder 50 may preferably be angled downward for drainage. An angle of between about 10-60 degrees, including all values and increments therein, is contemplated. In FIG. 2, the tube 52 may include an end cap 54 fitted with a drain 56 and drainage tube 58 for expelling water from a wet umbrella. In other embodiments, an absorbent material may line the inside of the tube 52 or a path for air flow may be created through the firewall and into the tube to aid in evaporating or draining any water. The air flow may comprise warm air from the engine compartment or ram air caused by the motion of the vehicle. In addition, the tube 52 may at least partially comprise a porous material which may allow air to pass through but retain moisture, which would flow out the drainage tube. While the tube is shown herein as round, it may comprise any elongated shape, including but not limited to, elliptical, square, rectangular, triangular, hexagonal, and octagonal.

The upper end 53 of the tube 52 may include an end cap or other finishing treatment such that the external appearance of the holder 50 is pleasing, complimentary to the rest of the vehicle interior and not distracting.

The door panel 22 may preferably include a depression 24 formed in the surface to coordinate with the holder 50 and allow the handle 62 of the umbrella 60 to extend beyond the surface of the instrument panel 30, for relatively easy access. The depression may further act as a retention device to prevent the umbrella from becoming a loose projectile in the interior of the vehicle in the event of an accident or aggressive driving. The holder 50 as described herein may be configured to accept collapsed umbrellas having overall length dimensions from about 8″ to about 16″, although any umbrella may be acceptable providing that the tube 52 has sufficient length. For shorter umbrellas, a cylindrical spacer may be first inserted into the tube such that the handle of the umbrella protrudes through the opening at the upper end of the tube, for relatively easy access. The tube may also include a depression or projection at the center of the lower end cap 54 to engage the tip of the umbrella and center it in the tube. This may assist in more uniform drying by allowing circulation of air around the body of the collapsed hood.

While illustrated herein as being preferably located in an end cap of the instrument panel, the present invention may be located in any trim panel in a vehicle, and may be adjacent a door, including but not limited to, a door panel, a seat or seat back, a headliner, pillar trim (A, B, C, D) and a console. In addition, the present invention may also be located in the end of a door, or in the surrounding sheet metal frame which may make up the opening which the door closes into.

The description and drawings illustratively set forth the presently preferred invention embodiment. We intend the description and drawings to describe this embodiment and not to limit the scope of the invention. Obviously, it is possible to modify these embodiments while remaining within the scope of the following claims. Therefore, within the scope of the claims one may practice the invention otherwise than as the description and drawings specifically show and describe.

What is claimed is:

1. A storage compartment in a vehicle for a collapsed umbrella having a handle, the vehicle including an instrument panel having ends, the compartment comprising:
a tube mounted in an end of said instrument panel, the tube having an open end adjacent a vehicle door for receiving said collapsed umbrella, the tube angled downward from said open end;
the vehicle door including a depression therein which is aligned with said open end such that, in a first position with said vehicle door closed, said depression receives a portion of said handle of said umbrella, and in a second position with said vehicle door open, said umbrella handle is exposed for access by an occupant.

2. The storage compartment of claim 1 wherein said tube is angled downward at an angle of about 10 to 60 degrees.

3. The storage compartment of claim 1 wherein said tube includes a lower end located opposite said open end and includes a drain located in said lower end.

4. The storage compartment of claim 1 wherein said tube includes an absorbent liner.

5. The storage compartment of claim 1 wherein said tube is porous.

6. The storage compartment of claim 1 wherein said tube provides a flow of air through said tube in response to motion of said vehicle.

7. A storage compartment in a vehicle for a collapsed umbrella having a handle, the vehicle including a trim component located adjacent a vehicle door, the compartment comprising:
a tube mounted in said trim component, the tube having an open end adjacent said vehicle door for receiving said collapsed umbrella, the tube angled downward from said open end;
the vehicle door including a depression therein which is aligned with said open end such that, in a first position with said vehicle door closed, said depression receives a portion of said handle of said umbrella and in a second position with said vehicle door open, said umbrella handle is exposed for access by an occupant.

8. The storage compartment of claim 7 wherein said trim component comprises a door panel, a pillar trim panel, a seat, a seatback or a console.
